(19) United States
(12) Patent Application Publication
(10) Pub. No.: US 2010/0243704 A1
(43) Pub. Date: Sep. 30, 2010

(54) Stapler

(76) Inventor: Peter David Dalton, Arcadia, CA (US)

Correspondence Address: Steven E. Shapiro, 1223 Wilshire Blvd., #461, Santa Monica, CA, 90403, US

(21) Appl. No.: 12/655,964

(22) Filed: Jan. 11, 2010

Related U.S. Application Data
(60) Provisional application No. 61/204,786, filed on Jan. 9, 2009.
(60) Provisional application No. 61/204,924, filed on Jan. 13, 2009.

(51) Int. Cl. B25C 5/02

(52) U.S. Cl. 227/155

(57) ABSTRACT

The present invention is a stapler with a bottom stapler leg and a top stapler leg operationally connected to bottom stapler leg. The top stapler leg has a compartment formed within the top of said top stapler leg to hold items such as paper clips. In the preferred embodiment, the compartment has a slidable cover that includes a large branding area for promotional advertising. In the preferred embodiment, the substantial branding area is a sunken surface. The sunken surface can be filled by a label and an epoxy dome.

### CROSS-REFERENCE TO RELATED APPLICATIONS

The applicant hereby claims benefit of U.S. Provisional Patent Application No. 61/204,786 (filed Jan. 9, 2009). The specification of said provisional patent application is incorporated herein by this reference as though set forth in full.

The applicant hereby claims benefit of U.S. Provisional Patent Application No. 61/204,924 (filed Jan. 13, 2009). The specification of said provisional patent application is incorporated herein by this reference as though set forth in full.

### STATEMENT REGARDING FEDERALLY SPONSORED RESEARCH OR DEVELOPMENT

Not Applicable

### FIELD OF INVENTION

The present invention relates to staplers.

### BACKGROUND OF THE INVENTION

A stapler is a common device used to bind material together by means of staples. A staple is a thin piece of wire in the shape of a square bracket that is driven by a device through sheets of paper or similar material and flattened to serve as a fastening. Staplers are very common devices on office desks. The present invention allows better utilization of space on an office desk by providing a compartment in a stapler for holding items such as paper clips. The compartment includes a cover that has a branding area for the application of promotional advertising. Preferably, a label bearing advertising is secured to the branding area and a clear, epoxy dome can be applied over the label.

### SUMMARY OF THE INVENTION

The present invention is a stapler with a bottom stapler leg and a top stapler leg operationally connected to bottom stapler leg. The top stapler leg has a compartment formed within the top of said top stapler leg to hold items such as paper clips. In the preferred embodiment, the compartment has a slidable cover that includes a large branding area for promotional advertising. In the preferred embodiment, the substantial branding area is a sunken surface. The sunken surface can be filled by a label and an epoxy dome.

### BRIEF DESCRIPTION OF THE DRAWINGS

The above and other objects and advantages of the present invention will be apparent upon consideration of the following detailed description, taken in conjunction with the accompanying drawings, in which reference characters refer to like parts throughout, and in which:

FIG. 1 shows the present invention.

### DETAILED DESCRIPTION OF THE INVENTION

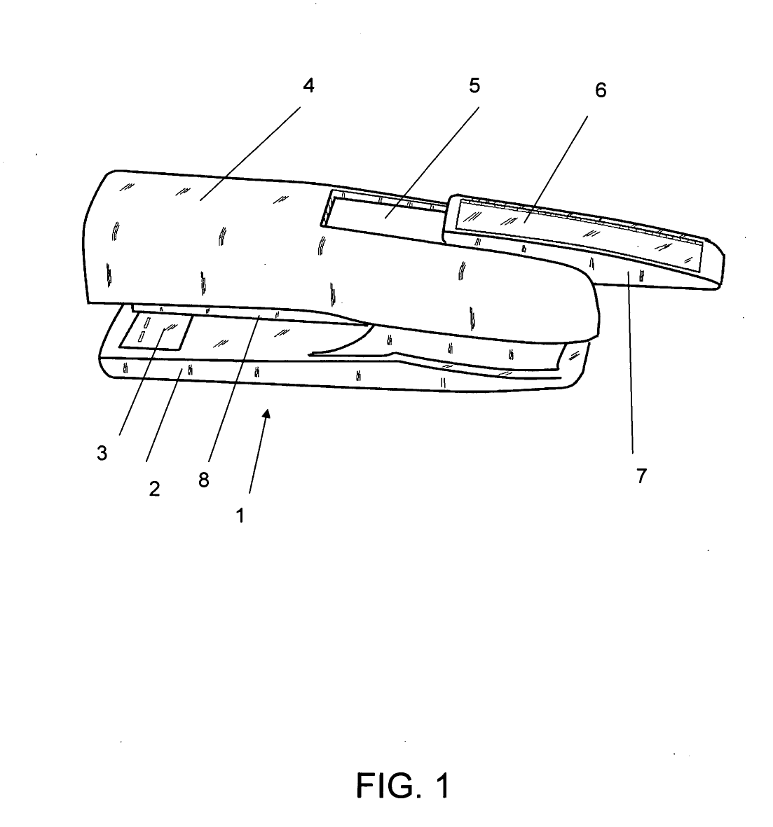

As can be seen in FIG. 1, the present invention is a stapler 1. The stapler includes a first stapler leg 2, which has a substantially flat bottom. The stapler 1 also has a second stapler leg 4 operationally connected to the first stapler leg. The second stapler leg includes a mechanism to hold and dispense staples 8 and the first stapler leg has a plate 3 for curling staples when staples are dispensed from said mechanism for holding and dispensing staples. The design and operation of staplers and stapler mechanisms are well known in the art.

The second stapler leg has a top; a compartment 5 formed within the top of the second stapler leg. The compartment is configured to hold items such as paper clips. The compartment 5 has a cover 7, which in the preferred embodiment is a slidable cover. The cover 7 has a substantial branding area 6 on the top. The branding area comprises most of the top surface of the cover. In the preferred embodiment, the branding area comprises at least 80% of the top surface of the cover and is a surface sunken into the top surface of the cover.

One of ordinary skill in the art will appreciate that the techniques, structures and methods of the present invention above are exemplary. The present invention can be implemented in various embodiments without deviating from the scope of the invention.

1. A stapler comprising: A first stapler leg, said first stapler leg comprising a substantially flat bottom; and, a second stapler leg operationally connected to said first stapler leg, said second stapler leg having a top; a compartment formed within the top of said second stapler leg, said compartment configured to hold items.

2. The stapler of claim 1, further comprising a cover for said compartment.

3. The stapler of claim 2, wherein the cover is slidable.

4. The stapler of claim 2, wherein the cover comprises a substantial branding area

5. The stapler of claim 4, wherein the branding area comprises most of the top surface of the cover.

6. The stapler of claim 5, wherein the branding area comprises at least 80% of the top surface of the cover.

7. The stapler of claim 4, wherein the branding area comprises a surface sunken into the top surface of the cover.

8. The stapler of claim 1, wherein said second stapler leg comprises a mechanism to hold and dispense staples.

9. The stapler of claim 8, wherein said first stapler leg comprises a plate for curling staples when staples are dispensed from said mechanism for holding and dispensing staples.
